(19) United States
(12) Patent Application Publication
(10) Pub. No.: US 2025/0306491 A1
(43) Pub. Date: Oct. 2, 2025

(54) TONER

(71) Applicant: CANON KABUSHIKI KAISHA, Tokyo (JP)

(72) Inventors: KENTARO KAMAE, Kanagawa (JP); HITOSHI SANO, Chiba (JP); NOBUHIRO YOSHIDA, Ibaraki (JP); KOHEI YOSHIYAMA, Chiba (JP); MIZUKI SAITO, Chiba (JP); TORU TAKAHASHI, Ibaraki (JP); YUU NISHIMURA, Chiba (JP); TAKAHO SHIBATA, Tokyo (JP)

(21) Appl. No.: 19/087,199

(22) Filed: Mar. 21, 2025

(30) Foreign Application Priority Data
Mar. 26, 2024 (JP) 2024-049226
Oct. 1, 2024 (JP) 2024-172551
Feb. 27, 2025 (JP) 2025-030138

(51) Int. Cl. G03G 9/087; G03G 9/083; G03G 9/09; G03G 9/097; G03G 9/107

(52) U.S. Cl. CPC G03G 9/08755; G03G 9/0834; G03G 9/08782; G03G 9/0904; G03G 9/09716; G03G 9/09725; G03G 9/108

(57) ABSTRACT

A toner includes toner particles containing a binder resin. The binder resin contains an amorphous resin A and a crystalline polyester C. The amorphous resin A is a polyester and has, as a structure that forms a polyester backbone, (i) a polyethylene terephthalate structural moiety and (ii) a unit having a specified structure. An SP value of the amorphous resin A is represented by SP_{A}, an SP value of the crystalline polyester C is represented by SP_{C}, and a formula 1.00≤SP_{A}−SP_{C}≤1.35 is satisfied. The toner contains a phosphorus element derived from a phosphorus compound, and a content of the phosphorus element in the toner based on a mass of the toner is 5 to 500 ppm.

### BACKGROUND

### Technical Field

The present disclosure relates to a toner used in an electrophotographic system, an electrostatic recording system, an electrostatic printing system, and the like.

### Description of the Related Art

In recent years, as electrophotographic full-color copiers have come into widespread use, there have been increasing demands for, besides a further increase in the speed and a higher image quality, improvements in additional performances, such as an energy-saving performance that can reduce running costs and dealing with a wide variety of media that can be applied not only to plain paper in offices but also to bookbinding and package printing. Furthermore, materials to be used also need to be considered to reduce their environmental load.

Specifically, in order to reduce the power consumption in a fixing step, toners with good low-temperature fixability capable of being fixed at a lower temperature have been required as toners that achieve energy saving.

Moreover, in coated cardboard, which is used for bookbinding and package printing, a so-called phenomenon “scratching” may occur. Specifically, contact with a person's fingernail or a sharp object causes a large depth of entering the media, resulting in an increase in the contact area, and the toner is peeled off from the media due to the strong stress from the outside, thereby causing image failure. In view of this, there has been a demand for a toner that can withstand external stress on coated cardboard and that has good scratch resistance.

In view of the above, Japanese Patent Laid-Open No. 2018-156074 proposes, as a toner having good low-temperature fixability, a toner containing a crystalline resin. Japanese Patent Laid-Open No. 2020-34647 proposes, as a toner having good scratch resistance, a toner containing inorganic fine particles having a high dielectric constant.

Meanwhile, in recent years, reuse and effective utilization of plastic products such as used PET bottles have become a major issue, including environmental and resource issues. As the number of PET bottles sold increases, an improvement in the recycling rate has been desired. The methods for recycling PET bottles include use in sheet applications such as trays for food, use in fiber applications such as clothing, and use of bottle-to-bottle, which is horizontal recycling.

The toner described in Japanese Patent Laid-Open No. 2018-156074 has a sharp melt property and thus exhibits good low-temperature fixability.

Japanese Patent Laid-Open No. 2020-34647 proposes a technique of improving scratch resistance by changing inorganic fine particles which are present at the interfaces between toner particles in a printed image and are the cause of degradation of scratch resistance to inorganic fine particles having a high dielectric constant.

However, in the toner having good low-temperature fixability as described in Japanese Patent Laid-Open No. 2018-156074, in a printed image, toner particles themselves, rather than the interfaces between the toner particles, may be broken, resulting in the formation of scratches. Thus, even if the technique described in Japanese Patent Laid-Open No. 2020-34647 is applied, scratching may occur.

As described above, there is room for improvement in achieving both low-temperature fixability and scratch resistance. Accordingly, the development of a toner that exhibits good low-temperature fixability and scratch resistance is urgently needed.

### SUMMARY

The present disclosure provides a toner that exhibits good low-temperature fixability and scratch resistance.

The present disclosure relates to a toner including toner particles containing a binder resin, wherein
the binder resin contains an amorphous resin A and a crystalline polyester C,
the amorphous resin A is a polyester and has, as a structure that forms a polyester backbone,
   (i) a polyethylene terephthalate structural moiety, and
   (ii) at least one structure selected from the group consisting of a unit represented by formula (1), a unit represented by formula (2), a unit represented by formula (3), and a unit represented by formula (4),

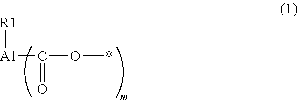

in formula (1), R1 represents an alkyl group having 6 to 16 carbon atoms or an alkenyl group having 6 to 16 carbon atoms,
A1 represents a hydrocarbon group,
* represents a bonding site in the polyester backbone, and
m represents an integer of 2 or more;

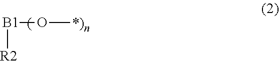

in formula (2), R2 represents an alkyl group having 6 to 16 carbon atoms or an alkenyl group having 6 to 16 carbon atoms,
B1 represents a hydrocarbon group,
* represents a bonding site in the polyester backbone, and
n represents an integer of 2 or more;

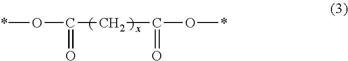

in formula (3), each * represents a bonding site in the polyester backbone, and
x represents an integer of 6 to 16;

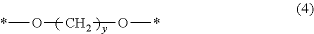

in formula (4), each * represents a bonding site in the polyester backbone, and
y represents an integer of 6 to 16;
an SP value of the amorphous resin A is represented by SP_{A} (cal/cm³)^{0.5}, an SP value of the crystalline polyester C is represented by SP_{C} (cal/cm³)^{0.5}, and SP_{A} and SP_{C} satisfy formula (C);

$$1. \leq {SP}_{A} - {SP}_{C} \leq 1.35 ; \qquad ( C )$$

the toner contains a phosphorus element derived from a phosphorus compound,
a content of the phosphorus element in the toner based on a mass of the toner is represented by W_{P} (ppm), and W_{P} satisfies formula (D);

$$5 \leq {W}_{P} \leq 500 . \qquad ( D )$$

Further features of the present disclosure will become apparent from the following description of exemplary embodiments.

### DESCRIPTION OF THE EMBODIMENTS

Hereinafter, the present disclosure will be described in detail. The present disclosure is not limited to the descriptions below. In the present disclosure, the expression “XX or more and YY or less” or “XX to YY” indicating a numerical range means a numerical range including the lower limit and the upper limit, which are end points, unless otherwise specified. When numerical ranges are described in stages, the upper limits and the lower limits of the numerical ranges can be appropriately combined. The term “monomer unit” refers to a structure in a polymer, the structure being formed by a reaction of a monomer. The term “crystalline polyester” refers to a polyester that exhibits a distinct endothermic peak in differential scanning calorimetry (DSC).

The inventors of the present disclosure have conducted studies on a toner having good low-temperature fixability and scratch resistance.

The inventors have first conducted studies on an improvement in scratch resistance by increasing the Young's modulus of the toner. Specifically, for scratch resistance, a certain degree of effect has been achieved by adjusting the molecular weight of the binder resin to a certain value or more, and selecting an aromatic monomer as the composition. It has been found that, however, the glass transition temperature and the softening point of the toner consequently increase, and low-temperature fixability is impaired.

That is, it has become clear that it is difficult to achieve both low-temperature fixability and scratch resistance by merely controlling the Young's modulus of the toner.

In view of the above, the inventors have considered providing a toner with “elastic deformation characteristics”, which allow the toner to temporarily deform in response to external force but return to its original state when the external force is released, instead of reducing deformation by increasing the Young's modulus. Specifically, the inventors have conducted studies with the aim of providing a toner having characteristics described below while exhibiting good low-temperature fixability.
(i) The three-dimensional structure can be flexibly deformed in a direction in which external force is applied.
(ii) Upon removal of the external force, it is possible to return to the original three-dimensional structure.

Such a toner can be achieved by the following configuration.

Specifically, a toner according to the present disclosure is a toner including toner particles containing a binder resin, in which
the binder resin contains an amorphous resin A and a crystalline polyester C,
the amorphous resin A is a polyester and has, as a structure that forms a polyester backbone,
(i) a polyethylene terephthalate structural moiety, and
(ii) at least one structure (hereinafter, also referred to as “unit”) selected from the group consisting of a unit represented by formula (1), a unit represented by formula (2), a unit represented by formula (3), and a unit represented by formula (4),

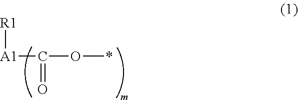

in formula (1), R¹ represents an alkyl group having 6 to 16 carbon atoms or an alkenyl group having 6 to 16 carbon atoms,
A1 represents a hydrocarbon group,
* represents a bonding site in the polyester backbone, and
m represents an integer of 2 or more;

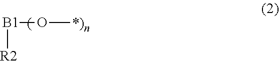

in formula (2), R2 represents an alkyl group having 6 to 16 carbon atoms or an alkenyl group having 6 to 16 carbon atoms,
B1 represents a hydrocarbon group,
* represents a bonding site in the polyester backbone, and
n represents an integer of 2 or more;

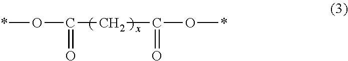

in formula (3), each * represents a bonding site in the polyester backbone, and
x represents an integer of 6 to 16;

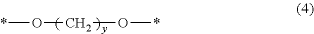

in formula (4), each * represents a bonding site in the polyester backbone, and
y represents an integer of 6 to 16;
an SP value of the amorphous resin A is represented by SP_{A} (cal/cm³)^{0.5}, an SP value of the crystalline polyester C is represented by SP_{C} (cal/cm³)^{0.5}, and SP_{A} and SP_{C} satisfy formula (C);

$$1. \leq {SP}_{A} - {SP}_{C} \leq 1.35 ; \qquad ( C )$$

the toner contains a phosphorus element derived from a phosphorus compound,
a content of the phosphorus element in the toner based on a mass of the toner is represented by W_{P} (ppm), and W_{P} satisfies formula (D);

$$5 \leq {W}_{P} \leq 500 . \qquad ( D )$$

The mechanism by which both low-temperature fixability and scratch resistance are achieved is inferred as follows.

The amorphous resin A has at least one structure selected from the group consisting of the unit represented by formula (1), the unit represented by formula (2), the unit represented by formula (3), and the unit represented by formula (4). In addition, the SP values of the amorphous resin A and the crystalline polyester C are controlled. The amorphous resin A has affinity with the crystalline polyester C due to these features. Therefore, in a fixed image, the amorphous resin A is influenced by the crystalline polyester C and becomes flexible. Since this structure disperses applied external force, the three-dimensional structure can be flexibly deformed in the direction in which the external force is applied without breakage of the molecular chain. Furthermore, since the amorphous resin A contains the polyethylene terephthalate structural moiety, the amorphous resin A has a repeating structure of a condensate of terephthalic acid and ethylene glycol in the polyester backbone. In a structure derived from ethylene glycol (hereinafter, also referred to as an ethylene glycol-derived structure) of the polyethylene terephthalate structural moiety, both terminals of ethylene glycol have been subjected to an esterification reaction; therefore, the structure has ester groups with a very close molecular distance corresponding to two carbon atoms. Therefore, the amorphous resin A has ester groups localized in the resin. In addition, the phosphorus compound in which the three unshared electron pairs in the outermost shell react also has bonding points with a very close molecular distance. Therefore, the amorphous resin A can form a three-dimensional crosslinked structure due to an interaction between the phosphorus element of the phosphorus compound serving as a center and the ester groups localized in the amorphous resin A. With this structure, upon removal of the applied external force, it is possible to return from the deformed state to the original three-dimensional structure. As described above, the configuration of the present disclosure is considered to provide good low-temperature fixability and scratch resistance.

The amorphous resin A in the present disclosure has, as a structure that forms a polyester backbone, at least one structure selected from the group consisting of the unit represented by formula (1), the unit represented by formula (2), the unit represented by formula (3), and the unit represented by formula (4). The structure of the long-chain hydrocarbon group such as an alkyl group or an alkenyl group included in the unit represented by formula (1), the unit represented by formula (2), the unit represented by formula (3), and the unit represented by formula (4) is a structure having relatively lower polarity than the above-described ethylene glycol-derived structure of the polyethylene terephthalate structural moiety. Accordingly, the structure of the long-chain hydrocarbon group such as an alkyl group or an alkenyl group included in the unit represented by formula (1), the unit represented by formula (2), the unit represented by formula (3), and the unit represented by formula (4) becomes flexible due to an increase in the affinity with the crystalline polyester C. Since this structure disperses applied external force, the three-dimensional structure can be flexibly deformed in the direction in which the external force is applied without breakage of the molecular chain.

As a result, an improvement in elastic deformation is realized to provide good scratch resistance. Furthermore, SP_{A} (cal/cm³)^{0.5} of the amorphous resin A and SP_{C} (cal/cm³)^{0.5} of the crystalline polyester C in the present disclosure satisfy formula (C) above. When SP_{A}−SP_{C} satisfies formula (C) above, the amorphous resin A and the crystalline polyester C are likely to be compatible with each other. Thus, the crystalline polyester C can act smoothly on the structure of the amorphous resin A having a long-chain hydrocarbon group such as an alkyl group or an alkenyl group. Therefore, this structure becomes flexible due to an increase in the affinity with the crystalline polyester C. Since the structure disperses applied external force, the three-dimensional structure can be flexibly deformed in the direction in which the external force is applied without breakage of the molecular chain. As a result, an improvement in elastic deformation characteristics is realized to provide good scratch resistance.

Furthermore, the toner according to the present disclosure contains a phosphorus element derived from a phosphorus compound, and W_{P} (ppm) satisfies formula (D) above. When the content of the phosphorus element in the toner satisfies formula (D) above, it is indicated that the phosphorus element is present in such a sufficient amount that the phosphorus element serves as the center and interacts with ester groups localized in the amorphous resin A to form a three-dimensional crosslinked structure. That is, the formula represents the minimum amount of phosphorus element that can flexibly change the three-dimensional structure in a direction in which external force is applied without breakage of the molecular chain to disperse the applied external force, and the maximum amount of phosphorus element that can ensure a certain plastic deformation capable of ensuring low-temperature fixability.

In the toner according to the present disclosure, W_{EG} (% by mole) preferably satisfies formula (E) below from the viewpoint of good low-temperature fixability and scratch resistance. Note that W_{EG} (% by mole) is a ratio of an ethylene glycol-derived structure of the polyethylene terephthalate structural moiety to a total number of moles of an alcohol-derived structure and a carboxylic acid-derived structure forming the polyester backbone in the amorphous resin A. In the calculation of W_{EG} (% by mole), the polyethylene terephthalate moiety is separated into a unit derived from ethylene glycol and a unit derived from terephthalic acid to deal with the number of moles.

$$12.6 \leq {W}_{EG} \leq 24. 8 \qquad ( E )$$

When W_{EG} is 12.6% by mole or more, applied external force is dispersed, and thus the three-dimensional structure can be more flexibly deformed in the direction in which the external force is applied without breakage of the molecular chain, and scratch resistance is improved. When W_{EG} is 24.8% by mole or less, a certain plastic deformation capable of ensuring low-temperature fixability can be ensured.

In the toner according to the present disclosure, W_{CH} (% by mole) preferably satisfies formula (F) below from the viewpoint of good low-temperature fixability and scratch resistance. Note that W_{CH} (% by mole) is a ratio of a total of the unit represented by formula (1), the unit represented by formula (2), the unit represented by formula (3), and the unit represented by formula (4) to the total number of moles of an alcohol-derived structure and a carboxylic acid-derived structure forming the polyester backbone in the amorphous resin A. In the calculation of W_{CH} (% by mole), the polyethylene terephthalate moiety is separated into a unit derived from ethylene glycol and a unit derived from terephthalic acid to deal with the number of moles.

$$5.6 \leq {W}_{CH} \leq 14.6 \qquad ( F )$$

When W_{CH} is 5.6% by mole or more, the affinity between the long-chain hydrocarbon group such as an alkyl group or an alkenyl group in the amorphous resin A and the crystalline polyester C is further increased. Thus, upon removal of the external force, it is possible to return to the original three-dimensional structure. As a result, scratch resistance is improved. When W_{CH} is 14.6% by mole or less, applied external force is dispersed, and thus the three-dimensional structure can be flexibly changed in the direction in which the external force is applied without breakage of the molecular chain, and scratch resistance is improved.

The crystalline polyester C in the present disclosure may be a modified crystalline polyester having a structure in which a hydroxy group at a terminal of the main chain is terminally modified with an aliphatic monocarboxylic acid having 16 to 31 carbon atoms or a modified crystalline polyester having a structure in which a carboxy group at a terminal of the main chain is terminally modified with an aliphatic monoalcohol having 15 to 30 carbon atoms. When the crystalline polyester C is the above modified crystalline polyester, the crystalline polyester C is sufficiently longer than the structure of the long-chain hydrocarbon group such as an alkyl group or an alkenyl group in the amorphous resin A; therefore, flexibility can be further enhanced. In addition, since this structure disperses applied external force, the three-dimensional structure can be flexibly deformed in the direction in which the external force is applied without breakage of the molecular chain, and good scratch resistance is provided.

W_{CH} (% by mole) and W_{EG} (% by mole) of the toner according to the present disclosure preferably satisfy formula (G) below in view of good scratch resistance.

$$0.42 \leq {W}_{CH} / {W}_{E G} \leq 0.68 \qquad ( G )$$

When W_{CH}/W_{EG} is 0.42 or more, upon removal of the applied external force, it is possible to return to the original three-dimensional structure. When W_{CH}/W_{EG} is 0.68 or less, the applied external force is dispersed, and thus the three-dimensional structure can be flexibly changed in the direction in which the external force is applied without breakage of the molecular chain,

W_{EG} (% by mole) and W_{P} (ppm) of the toner according to the present disclosure preferably satisfy formula (H) below in view of good scratch resistance.

$$0.05 \leq {W}_{E G} / {W}_{P} \leq 0.11 \qquad ( H )$$

When W_{EG}/W_{P} is 0.05 (% by mole/ppm) or more, a certain plastic deformation capable of ensuring low-temperature fixability can be ensured. When W_{EG}/W_{P} is 0.11 (% by mole/ppm) or less, upon removal of the applied external force, it is possible to return to the original three-dimensional structure.

A ratio of a content (parts by mass) of the crystalline polyester C relative to 100 parts by mass of the binder resin of the toner according to the present disclosure is represented by W_{C} (% by mass), and W_{C} and W_{CH} preferably satisfy formula (I) below in view of low-temperature fixability and scratch resistance.

$$40. \leq {W}_{CH} / {W}_{C} \leq 145. \qquad ( I )$$

When W_{CH}/W_{C} is 40.0 (% by mole/% by mass) or more, applied external force is dispersed, and thus the three-dimensional structure can be flexibly deformed in the direction in which the external force is applied without breakage of the molecular chain. When W_{CH}/W_{C} is 145.0 (% by mole/% by mass) or less, a certain plastic deformation capable of ensuring low-temperature fixability can be ensured.

### Amorphous Resin A

The amorphous resin A is a polyester and has, as a structure that forms a polyester backbone, (i) and (ii) below:
(i) a polyethylene terephthalate structural moiety
(ii) at least one structure selected from the group consisting of a unit represented by formula (1), a unit represented by formula (2), a unit represented by formula (3), and a unit represented by formula (4)

The polyethylene terephthalate structure used in the amorphous resin A is obtained by polycondensation of ethylene glycol and terephthalic acid.

The synthesis of the polyester can be conducted in an inert gas atmosphere, preferably in the presence of an esterification catalyst, and optionally, in the presence of an esterification promoter, a polymerization inhibitor, etc. preferably at a temperature of 180° C. or higher and 250° C. or lower.

Examples of esterification catalysts include tin compounds such as dibutyltin oxide and tin (II) 2-ethylhexanoate; and titanium compounds such as titanium diisopropylate bistriethanolaminate. Of these, a tin compound such as tin (II) 2-ethylhexanoate is preferred.

The amount of esterification catalyst used is preferably 0.01 parts by mass or more, more preferably 0.1 parts by mass or more, and preferably 1.5 parts by mass or less, more preferably 1.0 part by mass or less relative to 100 parts by mass of raw material monomers (an alcohol component, a carboxylic acid component, and PET). Examples of esterification promoters include gallic acid. The amount of esterification promoter used is preferably 0.001 parts by mass or more, more preferably 0.01 parts by mass or more, and preferably 0.5 parts by mass or less, more preferably 0.1 parts by mass or less relative to 100 parts by mass of the raw material monomers. Examples of polymerization inhibitors include tert-butyl catechol. The amount of polymerization inhibitor used is preferably 0.001 parts by mass or more, more preferably 0.01 parts by mass or more, and preferably 0.5 parts by mass or less, more preferably 0.1 parts by mass or less relative to 100 parts by mass of the raw material monomers.

In the synthesis of the polyester, polyethylene terephthalate may be present from the start of the condensation polymerization reaction or may be added to the reaction system in the middle of the condensation polymerization reaction. In order that the polyethylene terephthalate structural moiety is incorporated into the main backbone of the polyester in a block shape to a certain degree, the timing of addition of polyethylene terephthalate is preferably at a stage at which the reaction rate of the alcohol component and the carboxylic acid component is 10% or less, more preferably 5% or less. Herein, the reaction rate refers to a value represented by the following formula:

Amount of produced reaction water (mol)/amount of water produced (mol) in the case where all components are assumed to have reacted×100

The polyethylene terephthalate structural moiety contained in the amorphous resin A may be a repeating structure of a condensate of terephthalic acid and EG, represented by formula (5) below. In formula (5), p is preferably 3 or more and 10 or less, more preferably 4 or more and 8 or less. Within this range, the structure derived from EG included in the polyethylene terephthalate structural moiety contained in the amorphous resin A is more suitably localized, and a higher scratch resistance is achieved between the localized structure derived from EG and a phosphorus element.

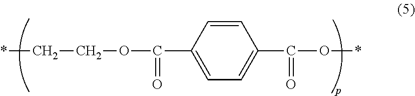

(In formula (5), * represents a bonding site in the polyester backbone, and p represents an integer of 3 to 10.)

For the polyethylene terephthalate structural moiety contained in the amorphous resin A, used polyethylene terephthalate (so-called recycled PET) can be used. Reusing polyethylene terephthalate is preferable from an environmental perspective.

Used PET is collected, and the collected PET is washed, sorted so as to avoid mixing with other materials and dust. After labels and the like are removed, the PET is crushed into flakes or the like. The crushed product can be used as it is, or a product obtained by kneading the crushed product and then roughly crushing the kneaded product can also be used. If chemical substances adsorbed on the surfaces of PET bottles cannot be sufficiently removed by usual washing, alkali washing may be performed. If part of the crushed product is hydrolyzed by alkali washing, in order to recover the decreased degree of polymerization, the washed crushed product may be melted and pelletized, and the resulting pellets may be subjected to solid-phase polymerization. The solid-phase polymerization step can be performed by subjecting washed flakes or pellets obtained by melt-extruding the flakes and pelletizing the extruded product to continuous solid-phase polymerization in an inert gas such as nitrogen gas, a rare gas, or the like at 180° C. to 245° C., preferably 200° C. to 240° C. Alternatively, a product obtained by degrading a washed crushed product into monomer units by depolymerization and subjected to resynthesis may be used.

The recycled PET is not limited to the used PET described above, and off-spec PET fiber waste or pellets discharged from factories may be used.

In order to incorporate at least one unit selected from the group consisting of the unit represented by formula (1), the unit represented by formula (2), the unit represented by formula (3), and the unit represented by formula (4) into the amorphous resin A, the following monomers can be used.

Examples thereof include 1,6-hexanediol, 1,7-heptanediol, 1,8-octanediol, 1,9-nonanediol, 1,10-decanediol, 1,11-undecanediol, 1,12-dodecanediol, suberic acid, azelaic acid, sebacic acid, undecanedioic acid, dodecanedioic acid, hexadecanedioic acid, octadecanedioic acid, dodecenylsuccinic acid, n-octylsuccinic acid, isododecenylsuccinic acid, dodecylsuccinic acid, isooctenylsuccinic acid, and hexadecylsuccinic acid.

Among the unit represented by formula (1), the unit represented by formula (2), the unit represented by formula (3), and the unit represented by formula (4), the unit represented by formula (1) and the unit represented by formula (2) are preferred. Since an alkyl group or alkenyl group having 6 to 16 carbon atoms is branched from the main chain of the polyester backbone, affinity with the release agent is increased, and dispersibility of the release agent is further improved.

As the components for obtaining the amorphous resin A, besides the structures and monomers described above, other polyhydric alcohols (dihydric or higher alcohols), polycarboxylic acids (divalent or higher carboxylic acids), acid anhydrides thereof, or lower alkyl esters thereof may be used.

The following polyhydric alcohol monomers can be used as polyhydric alcohol monomers. Examples of dihydric alcohol components include ethylene glycol, propylene glycol, 1,3-butanediol, 1,4-butanediol, 2,3-butanediol, diethylene glycol, triethylene glycol, neopentyl glycol, 2-ethyl-1,3-hexanediol, hydrogenated bisphenol A, bisphenol and derivatives thereof represented by formula (A);

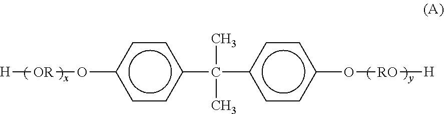

where each R represents an ethylene or propylene group, x and y are each an integer of 0 or more, and the average of x+y is 0 or more and 10 or less; and
diols represented by formula (B);

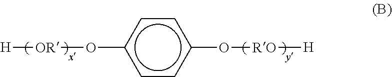

where each R′ represents —CH₂—CH₂—, —CH₂—CH(—CH₃)—, or —CH₂—C(—CH₃)₂—, x′ and y′ are each an integer of 0 or more, and the average of x′+y′ is 0 or more and 10 or less.

Examples of trihydric or higher alcohol components include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Of these, glycerol, trimethylolpropane, and pentaerythritol are preferably used.

These dihydric alcohols and trihydric or higher alcohols may be used alone or in combination of two or more thereof.

Examples of divalent carboxylic acid components include maleic acid, fumaric acid, citraconic acid, itaconic acid, glutaconic acid, phthalic acid, isophthalic acid, terephthalic acid, succinic acid, azelaic acid, malonic acid, anhydrides of these acids, and lower alkyl esters thereof. Of these, maleic acid, fumaric acid, and terephthalic acid are preferably used.

Examples of trivalent or higher carboxylic acids, acid anhydrides thereof, and lower alkyl esters thereof include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, empol trimer acid, acid anhydrides thereof, and lower alkyl esters thereof. Of these, in particular, 1,2,4-benzenetricarboxylic acid, i.e., trimellitic acid, or a derivative thereof is preferably used because it is inexpensive and the reaction control is easy. These divalent carboxylic acids and the like and trivalent or higher carboxylic acids may be used alone or in combination of two or more thereof.

The method for producing the amorphous resin A is not particularly limited, and a known method can be employed. For example, the alcohol monomer and the carboxylic acid monomer described above are charged at the same time and polymerized through an esterification reaction or a transesterification reaction, and a condensation reaction to produce a polyester. The polymerization temperature is not particularly limited and is preferably in a range of 180° C. to 290° C. In the polymerization of the polyester unit, a polymerization catalyst such as a titanium-based catalyst, a tin-based catalyst, zinc acetate, antimony trioxide, or germanium dioxide can be used. In particular, the amorphous resin A may be a polyester polymerized using a tin-based catalyst.

The amorphous resin A may be a polyester having a vinyl resin moiety. The method for obtaining a polyester to which a vinyl resin is bonded may be a method using a monomer component that can react with both a vinyl resin and a polyester unit. Such a monomer may be a monomer having an unsaturated double bond and a carboxy group or a hydroxy group. Examples thereof include unsaturated dicarboxylic acids such as phthalic acid, maleic acid, citraconic acid, itaconic acid, anhydrides thereof, acrylates, and methacrylates.

The peak molecular weight of the amorphous resin A according to the present disclosure is preferably 3,500 or more and 20,000 or less from the viewpoint of, for example, low-temperature fixability. The glass transition temperature is preferably 40° C. to 70° C.

In addition to the amorphous resin A, various resins known as binder resins in the related art can be used as amorphous resins in combination. Examples of such resins include phenolic resins, natural resin-modified phenolic resins, natural resin-modified maleic resins, acrylic resins, methacrylic resins, polyvinyl acetate resins, silicone resins, polyester resins, polyurethanes, polyamide resins, furan resins, epoxy resins, xylene resins, polyvinyl butyral, terpene resins, coumarone-indene resins, and petroleum-based resins.

### Crystalline Polyester C

As monomers used in the polyester unit of the crystalline polyester C used in the toner according to the present disclosure, a polyhydric alcohol (dihydric or trihydric or higher alcohol) and a polycarboxylic acid (divalent or trivalent or higher carboxylic acid), an acid anhydride thereof, or a lower alkyl ester thereof are used.

The polyhydric alcohol monomer used in the polyester unit of the crystalline polyester C may be any of polyhydric alcohol monomers below.

The polyhydric alcohol monomer is not particularly limited, and may be a chain (in particular, linear) aliphatic diol. Examples thereof include ethylene glycol, diethylene glycol, triethylene glycol, 1,2-propylene glycol, 1,3-propylene glycol, dipropylene glycol, 1,4-butanediol, 1,4-butanediene glycol, trimethylene glycol, tetramethylene glycol, pentamethylene glycol, hexamethylene glycol, octamethylene glycol, nonamethylene glycol, decamethylene glycol, and neopentyl glycol. Of these, linear aliphatic a, @-diols such as ethylene glycol, diethylene glycol, 1,4-butanediol, and 1,6-hexanediol can be particularly used.

In the present disclosure, polyhydric alcohol monomers other than the above polyhydric alcohols may be used. Examples of dihydric alcohol monomers among the polyhydric alcohol monomers include aromatic alcohols, such as polyoxyethylenated bisphenol A and polyoxypropylenated bisphenol A; and 1,4-cyclohexanedimethanol. Examples of trihydric or higher alcohol monomers among the polyhydric alcohol monomers include aromatic alcohols such as 1,3,5-trihydroxymethylbenzene; and aliphatic alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, and trimethylolpropane.

The polycarboxylic acid monomer used in the polyester unit of the crystalline polyester C may be any of polycarboxylic acid monomers below.

The polycarboxylic acid monomer is not particularly limited, and may be a chain (in particular, linear) aliphatic dicarboxylic acid. Specific examples thereof include oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid. Acid anhydrides thereof, hydrolysates of lower alkyl esters thereof, etc. are also included.

In the present disclosure, polycarboxylic acids other than the above polycarboxylic acid monomers may be used. Examples of divalent carboxylic acids among other polycarboxylic acid monomers include aromatic carboxylic acids such as isophthalic acid and terephthalic acid; aliphatic carboxylic acids such as n-dodecylsuccinic acid and n-dodecenylsuccinic acid; and alicyclic carboxylic acids such as cyclohexanedicarboxylic acid. Acid anhydrides thereof, lower alkyl esters thereof, etc. are also included. Examples of trivalent or higher carboxylic acids among other carboxylic acid monomers include aromatic carboxylic acids such as 1,2,4-benzenetricarboxylic acid (trimellitic acid), 2,5,7-naphthalenetricarboxylic acid, 1,2,4-naphthalenetricarboxylic acid, and pyromellitic acid; and aliphatic carboxylic acids such as 1,2,4-butanetricarboxylic acid, 1,2,5-hexanetricarboxylic acid, and 1,3-dicarboxyl-2-methyl-2-methylenecarboxypropane. Derivatives such as acid anhydrides thereof and lower alkyl esters thereof are also included.

The crystalline polyester C may be a modified crystalline polyester having a structure in which a hydroxy group at a terminal of the main chain is terminally modified with an aliphatic monocarboxylic acid having 16 to 31 carbon atoms or a modified crystalline polyester having a structure in which a carboxy group at a terminal of the main chain is terminally modified with an aliphatic monoalcohol having 15 to 30 carbon atoms.

Examples of aliphatic monocarboxylic acid monomers having 16 to 31 carbon atoms include palmitic acid (hexadecanoic acid), margaric acid (heptadecanoic acid), stearic acid (octadecanoic acid), nonadecylic acid, arachidic acid (icosanoic acid), henicosanoic acid, docosanoic acid, tetracosanoic acid, hexacosanoic acid, octacosanoic acid, and triacontanoic acid.

Examples of aliphatic monoalcohols having 15 to 30 carbon atoms include cetyl alcohol, palmityl alcohol (hexadecanol), margaryl alcohol (heptadecanol), stearyl alcohol (octadecanol), nonadecanol, arachidyl alcohol (icosanol), heneicosanol, behenyl alcohol, lignoceryl alcohol, ceryl alcohol, 1-heptacosanol, montanyl alcohol, 1-nonacosanol, and myricyl alcohol.

The crystalline polyester C can be produced in accordance with a typical polyester synthesis method.

For example, a crystalline polyester can be obtained by subjecting the carboxylic acid monomer and the alcohol monomer to an esterification reaction or a transesterification reaction, and then causing a polycondensation reaction under reduced pressure or by introducing nitrogen gas according to an ordinary method. Subsequently, the above-described aliphatic compound is further added and an esterification reaction is performed. Thus, a desired crystalline polyester can be provided.

The esterification reaction or the transesterification reaction can be performed using a typical esterification catalyst or transesterification catalyst such as titanium butoxide, dibutyltin oxide, manganese acetate, or magnesium acetate, as needed.

The polycondensation reaction can be performed using a typical polymerization catalyst, such as known catalysts, e.g., titanium butoxide, dibutyltin oxide, tin acetate, zinc acetate, tin disulfide, antimony trioxide, or germanium dioxide. The polymerization temperature and the amount of catalyst are not particularly limited and may be appropriately determined.

In the esterification or transesterification reaction or the polycondensation reaction, a method in which all the monomers are charged at once may be employed in order to increase the strength of the crystalline polyester to be obtained. Alternatively, for example, a method in which a divalent monomer is first caused to react, and a trivalent or higher monomer is then added and caused to react may be employed in order to reduce a low-molecular-weight component.

The melting point of the crystalline polyester C is preferably 70° C. to 110° C., more preferably 80° C. to 100° C. in view of low-temperature fixability. In the toner according to the present disclosure, the crystalline polyester C is preferably used in an amount of 3 parts by mass or more and 20 parts by mass or less per 100 parts by mass of the amorphous resin in view of low-temperature fixability, scratch resistance, and charge retention ability in high-temperature, high-humidity environments.

### Phosphorus Compound

Examples of the phosphorus compound used in the toner according to the present disclosure include trisodium phosphate, trimethyl phosphate, triethyl phosphate, tri-2-ethylhexyl phosphate, (trisisopropylphenyl) phosphate, triphenyl phosphate, tributyl phosphate, trimethyl phosphite, tributyl phosphite, and triphenyl phosphite. Of these, trivalent phosphorus compounds, which easily form three-dimensional crosslinking, are preferred.

The content of the phosphorus element and optimal W_{EG} and W_{P} for forming a three-dimensional crosslinked structure are as described above. Furthermore, in order to form the three-dimensional crosslinked structure, used polyethylene terephthalate (so-called recycled PET) may be used because polyethylene terephthalate blocks are likely to be formed, and thus ester groups with close molecular distances can be more likely to gather together to form a strong three-dimensional crosslinked structure. This structure can return to the original three-dimensional structure upon removal of applied external force.

### Wax

The toner particles may contain a wax. Examples of waxes include the following: hydrocarbon waxes, such as low-molecular-weight polyethylene, low-molecular-weight polypropylene, alkylene copolymers, microcrystalline wax, paraffin wax, and Fischer-Tropsch wax; oxides of hydrocarbon waxes, such as polyethylene oxide wax, and block copolymers thereof; waxes whose main component is a fatty acid ester, such as carnauba wax; partially or wholly deoxidized fatty acid esters, such as deoxidized carnauba wax; saturated linear fatty acids, such as palmitic acid, stearic acid, and montanic acid; unsaturated fatty acids, such as brassidic acid, eleostearic acid, and parinaric acid; saturated alcohols, such as stearyl alcohol, aralkyl alcohol, behenyl alcohol, carnaubyl alcohol, ceryl alcohol, and melissyl alcohol; polyhydric alcohols, such as sorbitol; esters of a fatty acid, such as palmitic acid, stearic acid, behenic acid, or montanic acid, and an alcohol, such as stearyl alcohol, aralkyl alcohol, behenyl alcohol, carnaubyl alcohol, ceryl alcohol, or melissyl alcohol; fatty acid amides, such as linoleic acid amide, oleic acid amide, and lauric acid amide; saturated fatty acid bisamides such as methylene-bis-stearic acid amide, ethylene-bis-capric acid amide, ethylene-bis-lauric acid amide, and hexamethylene-bis-stearic acid amide; unsaturated fatty acid amides, such as ethylene-bis-oleic acid amide, hexamethylene-bis-oleic acid amide, N,N′-dioleyl adipic acid amide, and N,N′-dioleyl sebacic acid amide; aromatic bisamides, such as m-xylene bis-stearic acid amide and N,N′-distearyl isophthalic acid amide; fatty acid metal salts (generally referred to as metal soap), such as calcium stearate, calcium laurate, zinc laurate, and magnesium stearate; waxes prepared by grafting an aliphatic hydrocarbon wax with a vinyl monomer, such as styrene or acrylic acid; partially esterified products of a fatty acid and a polyhydric alcohol, such as behenic acid monoglyceride; and methyl ester compounds having a hydroxyl group obtained by hydrogenation of vegetable fat and oil.

Of these waxes, hydrocarbon waxes such as paraffin wax and Fischer-Tropsch wax can be used from the viewpoint of suppressing blooming. That is, the wax preferably includes a hydrocarbon wax. The wax is more preferably Fischer-Tropsch wax.

From the viewpoint of suppressing blooming, the content of the wax is preferably 2 parts by mass to 10 parts by mass, more preferably 3 parts by mass to 8 parts by mass relative to 100 parts by mass of the binder resin.

The melting point of the wax is preferably 60° C. or higher and 120° C. or lower, more preferably 90° C. or higher and 110° C. or lower.

### Colorant

The toner particles may contain a colorant as needed. Examples of colorants include the following. Examples of a black colorant include carbon black; and colorants adjusted to black using a yellow colorant, a magenta colorant, and a cyan colorant. As the colorant, a pigment may be used alone, or a dye and a pigment may be used in combination. In view of the image quality of full-color images, a dye and a pigment can be used in combination.

Examples of pigments for a magenta toner include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Red 1, 2, 10, 13, 15, 23, 29, and 35.

Examples of dyes for a magenta toner include oil-soluble dyes such as C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; and C.I. Disperse Violet 1; and basic dyes such as C.I. Basic Red 1, 2, 9, 12, 13, 14, 15, 17, 18, 22, 23, 24, 27, 29, 32, 34, 35, 36, 37, 38, 39, and 40; C.I. Basic Violet 1, 3, 7, 10, 14, 15, 21, 25, 26, 27, and 28.

Examples of pigments for a cyan toner include C.I. Pigment Blue 2, 3, 15:2, 15:3, 15:4, 16, and 17; C.I. Vat Blue 6; C.I. Acid Blue 45; and copper phthalocyanine pigments having a phthalocyanine skeleton substituted with 1 to 5 phthalimidomethyl groups. Examples of dyes for a cyan toner include C.I. Solvent Blue 70.

Examples of pigments for a yellow toner include C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20. C.I. Pigment Yellow 180 treated with 1% to 10% by mass of a nonionic surfactant (such as a polyoxyethylene alkyl ether) can be used as C.I. Pigment Yellow 180. Examples of dyes for a yellow toner include C.I. Solvent Yellow 162.

These colorants can be used alone, in combination as a mixture, or in the form of a solid solution.

Such a colorant is selected in accordance with the hue angle, color saturation, lightness value, light fastness, OHP transparency, and dispersibility in the toner particles.

The content of the colorant is preferably 0.1 parts by mass to 30.0 parts by mass relative to 100 parts by mass of the binder resin.

### Charge Control Agent

The toner particles may contain a charge control agent as needed. Incorporation of the charge control agent enables charge characteristics to be stabilized and enables an optimal triboelectric charging amount to be controlled according to the developing system. Known charge control agents can be used. In particular, a metal compound of an aromatic carboxylic acid, which is colorless, has a high toner charging speed, and can stably maintain a constant charge amount, may be used.

Examples of negative charge control agents include salicylic acid metal compounds, naphthoic acid metal compounds, dicarboxylic acid metal compounds, polymer compounds having sulfonic acid or carboxylic acid in a side chain, polymer compounds having a sulfonate or esterified sulfonic acid in a side chain, polymer compounds having a carboxylate or esterified carboxylic acid in a side chain, boron compounds, urea compounds, silicon compounds, and calixarenes.

The charge control agent may be internally added or externally added to the toner particles. The content of the charge control agent is preferably 0.2 parts by mass to 10.0 parts by mass, more preferably 0.5 parts by mass to 10.0 parts by mass relative to 100 parts by mass of the binder resin.

### Inorganic Fine Particles

The toner may contain inorganic fine particles as needed.

The inorganic fine particles may be internally added to the toner particles or may be mixed with the toner particles as an external additive. Examples of inorganic fine particles include fine particles, such as fine silica particles, fine titanium oxide particles, fine alumina particles, and fine particles of their complex oxides. Among the inorganic fine particles, fine silica particles and fine titanium oxide particles can be used for improving the flowability and uniformizing the charge. The inorganic fine particles may be hydrophobized with a hydrophobizing agent such as a silane compound, a silicone oil, or a mixture thereof.

### External Additive

Besides the inorganic fine particles described above, organic fine particles such as fine melamine-based resin particles and fine polytetrafluoroethylene resin particles may be used as an external additive.

From the viewpoint of improving flowability, the median diameter (D50) of the external additive is, on a number basis, preferably 10 nm or more and is preferably 250 nm or less, more preferably 200 nm or less, still more preferably 90 nm or less.

The content of the external additive is preferably 0.1 parts by mass to 10.0 parts by mass relative to 100 parts by mass of the toner particles. The toner particles and the external additive can be mixed using a known mixer such as a Henschel Mixer.

### Developer

The toner may be used as a one-component developer or, in order to further improve dot reproducibility or provide stable images for a long term, may be mixed with a magnetic carrier and used as a two-component developer.

Examples of the magnetic carrier include commonly known magnetic carriers such as iron oxide; metal particles such as particles of iron, lithium, calcium, magnesium, nickel, copper, zinc, cobalt, manganese, chromium, and rare earth elements, particles of alloys thereof, and particles of oxides thereof; magnetic materials such as ferrite; and a magnetic material-dispersed resin carrier (so-called resin carrier) containing a magnetic material and a binder resin that holds the magnetic material in a dispersed state.

In the case where the toner is mixed with a magnetic carrier and used as a two-component developer, the toner concentration in the two-component developer is preferably 2% by mass to 15% by mass, more preferably 4% by mass to 13% by mass.

### Method for Producing Toner Particles

The method for producing toner particles is not particularly limited, and a known method such as a pulverization method, a suspension polymerization method, a dissolution suspension method, an emulsion aggregation method, or a dispersion polymerization method can be employed. Of these, the pulverization method can be employed from the viewpoint of controlling a wax on the surfaces of toner particles. That is, the toner particles may be pulverized toner particles. A procedure for producing a toner by the pulverization method will be described below.

The pulverization method includes, for example, a raw material mixing step of mixing a crystalline polyester C and an amorphous resin A serving as a binder resin, a phosphorus compound, and, as needed, other components such as another amorphous resin, a wax, a colorant, and a charge control agent; a step of melt-kneading the mixed raw materials to provide a resin composition; and a step of pulverizing the resin composition to provide toner particles.

In the raw material mixing step, for example, predetermined amounts of a binder resin, a wax, and, as needed, other components such as a colorant and a charge control agent are weighed as materials constituting toner particles, combined, and mixed. Examples of the mixing device include a double-cone mixer, a V-type mixer, a drum-type mixer, a super mixer, a Henschel mixer, a Nauta mixer, and a Mechano Hybrid (manufactured by Nippon Coke & Engineering Co., Ltd.).

Next, the mixed materials are melt-kneaded to disperse the materials in the binder resin. In the melt-kneading step, a batch-type kneader such as a pressure kneader or a Banbury mixer, or a continuous kneader may be used. From the viewpoint of superiority of capability of continuous production, a single- or twin-screw extruder is mainly used. Examples thereof include a KTK-type twin-screw extruder (manufactured by Kobe Steel, Ltd.), a TEM-type twin-screw extruder (manufactured by Shibaura Machine Co., Ltd.), a PCM kneader (manufactured by Ikegai Corporation), a twin-screw extruder (manufactured by KCK), a Co-Kneader (manufactured by Buss AG), and Kneadex (manufactured by Nippon Coke & Engineering Co., Ltd.). Furthermore, the resin composition obtained by melt-kneading may be rolled with a two-roll or the like and cooled with water or the like in a cooling step.

The cooled material of the resin composition is then pulverized to a desired particle diameter in the pulverization step. In the pulverization step, first, the cooled material is roughly pulverized with a pulverizer such as a crusher mill, a hammer mill, or a feather mill. Subsequently, the resulting pulverized material is finely pulverized with a fine pulverizer such as a Kryptron System (manufactured by Kawasaki Heavy Industries, Ltd.), Super Rotor (produced by Nisshin Engineering Inc.), a turbo mill (manufactured by Turbo Kogyo Co., Ltd.), or an air-jet fine pulverizer.

The resulting pulverized particles are then optionally classified using a classifier or a sieving machine such as Elbow-Jet (manufactured by Nittetsu Mining Co., Ltd.) that employs an inertial classification system, Turboplex (manufactured by Hosokawa Micron Corporation) that employs a centrifugal classification system, TSP Separator (manufactured by Hosokawa Micron Corporation), or Faculty (manufactured by Hosokawa Micron Corporation).

Subsequently, if necessary, external additives, such as fine silica particles, are externally added to the surfaces of the toner particles to obtain a toner. Examples of devices used for external addition treatment include mixing devices such as a double-cone mixer, a V-type mixer, a drum-type mixer, a super mixer, a Henschel mixer, a Nauta mixer, a Mechano Hybrid (manufactured by Nippon Coke & Engineering Co., Ltd.), and Nobilta (manufactured by Hosokawa Micron Corporation).

Before or after the external addition treatment, hot-air treatment may be optionally performed to spheroidize the toner particles.

Methods for measuring various physical properties will be described below.

Method for Separating Each Material from Toner

Each material can be separated from a toner by utilizing the difference in solubility in a solvent between materials included in the toner or GPC. Various physical properties described below can be measured using the separated materials. First separation: The toner is dissolved in methyl ethyl ketone (MEK) at 23° C. to separate soluble matter (amorphous resin A, amorphous resin B, crystalline polyester C, and phosphorus compound) and insoluble matter (such as wax, colorant, and inorganic fine particles) from each other.

Second separation: The soluble matter (amorphous resin A, amorphous resin B, crystalline polyester C, and phosphorus compound) obtained in the first separation is dissolved in tetrahydrofuran (THF) at 23° C. to separate soluble matter (amorphous resin A, amorphous resin B, and phosphorus compound) and insoluble matter (crystalline polyester C) from each other.

Third separation: The insoluble matter (such as wax, colorant, and inorganic fine particles) obtained in the first separation is dissolved in MEK at 100° C. to separate soluble matter (wax) and insoluble matter (such as colorant, and inorganic fine particles) from each other. Fourth separation: The soluble matter (amorphous resin A, amorphous resin B, and phosphorus compound) obtained in the second separation is dissolved in tetrahydrofuran (THF) at 23° C., and the amorphous resin A, the amorphous resin B, and the phosphorus compound are separated from each other by preparative GPC.

### Method for Confirming Attribution of Various Monomer Units in Amorphous Resin and Crystalline Polyester and Method for Measuring Contents of the Monomer Units

The confirmation of the attribution of various monomer units in an amorphous resin and a crystalline polyester and the measurement of the contents of the monomer units are performed by 1H-NMR under the following conditions.
Measuring apparatus: FT NMR apparatus JNM-EX400 (manufactured by JEOL Ltd.)
Measurement frequency: 400 MHZ
Pulse condition: 5.0 μs
Frequency range: 10,500 Hz
Number of scans: 64
Measurement temperature: 30° C.
Specimen: A specimen is prepared by placing 50 mg of a measurement specimen in a sample tube with an inner diameter of 5 mm, adding deuterated chloroform (CDCl₃) as a solvent, and dissolving this measurement specimen in a thermostatic chamber at 40° C.

The structures of various monomer units are specified from the obtained ¹H-NMR chart, and integral values S₁, S₂, S₃, . . . , and Sn of peaks attributed to the monomer units are calculated.

The content of each monomer unit is determined using the integral values S₁, S₂, S₃, . . . , and Sn as follows. Note that n₁, n₂, n₃, . . . , and nₙ are each the number of hydrogen atoms in the respective monomer units.

$$Content of each monomer unit ( \% by mole ) = \{ ( {S}_{n} / {n}_{n} ) / ( ( {S}_{1} / {n}_{1} ) + ( {S}_{2} / {n}_{2} ) + ( {S}_{3} / {n}_{3} ) … + ( {S}_{n} / {n}_{n} ) ) \} \times 100$$

The numerator term of a similar operation is changed, and the content (% by mole) of each monomer unit is calculated. When a polymerizable monomer containing no hydrogen atoms is used as a monomer unit, ¹³C-NMR measurement, in which the nucleus to be measured is ¹³C, is performed in a single pulse mode, and the calculation is performed in the same manner by ¹H-NMR.

### Method for Calculating SP Values of Amorphous Resin and Crystalline Polyester

The SP values of an amorphous resin and a crystalline polyester are calculated in accordance with the calculation method proposed by Fedors.

Specifically, energy of evaporation (Δei), a molar volume (Δvi), and a molar ratio (j) in the resin are determined for each monomer unit. The SP value is calculated using these values from the following formula.

$$SP value {( cal / {cm}^{3} )}^{0.5} = {\{ ( Σ j \times Σ Δ ei ) / ( Σ j \times ΣΔ vi ) \}}^{0.5}$$

For the energy of evaporation (Δei) and the molar volume (Δvi) of an atom or an atomic group in the monomer unit, values described in “polym. Eng. Sci., 14 (2), 147-154 (1974)” are used.

### Method for Measuring Content W_{P} of Phosphorus Element in Toner

The content W_{P} (ppm) of a phosphorus element in a toner is measured using a simultaneous multi-element ICP emission spectrometer Vista-PRO (manufactured by Hitachi High-Tech Science Corporation).
Sample: 50 mg
Solvent: nitric acid 6 mL

The above sample and solvent are weighed, and decomposition treatment is performed using a microwave sample pretreatment device ETHOS UP (manufactured by Milestone General K.K.).
Temperature: The temperature is raised from 20° C. to 230° C. and held at 230° C. for 30 minutes.

The decomposition liquid is passed through filter paper (5C), then transferred to a 50 mL volumetric flask, and diluted to 50 mL with ultrapure water. The aqueous solution in the volumetric flask can be measured using a simultaneous multi-element ICP emission spectrometer Vista-PRO under conditions described below to quantify the content of the phosphorus element in the toner. The content is quantified by preparing a calibration curve using standard samples of the element to be quantified, and performing calculation on the basis of the calibration curve.
Conditions: RF power 1.20 kW
Ar gas: plasma flow 15.0 L/min
Auxiliary flow: 1.50 L/min
MFC: 1.50 L/min
Nebulizer: 0.90 L/min
Plunger pump speed: 15 rpm
Number of repetitions of measurement: 3
Measurement time: 1.0 s

### Method for Measuring Weight-Average Molecular Weight Mw of Amorphous Resin by GPC

The molecular weight (Mw) of THF-soluble matter of an amorphous resin is measured by gel permeation chromatography (GPC) as follows.

First, a toner is dissolved in tetrahydrofuran (THF) at room temperature over a period of 24 hours. The obtained solution is then filtered through a solvent-resistant membrane filter “Maishori Disc” (manufactured by Tosoh Corporation) having a pore diameter of 0.2 μm to obtain a sample solution. The sample solution is adjusted such that the concentration of the component soluble in THF is about 0.8% by mass. Measurement is performed using this sample solution under the following conditions.
Apparatus: HLC8120 GPC (detector: RI) (manufactured by Tosoh Corporation)
Columns: connected seven columns, Shodex KF-801, 802, 803, 804, 805, 806, and 807 (manufactured by Resonac Holdings Corporation)
Eluent: tetrahydrofuran (THF)
Flow rate: 1.0 mL/min
Oven temperature: 40.0° C.
Amount of sample injected: 0.10 mL

The molecular weight of a sample is calculated by using a molecular weight calibration curve prepared by using standard polystyrene resins (for example, trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation).

### Method for Measuring Weight-Average Molecular Weight of Crystalline Polyester by GPC

The weight-average molecular weight (Mw) of toluene-soluble matter of a crystalline polyester, the toluene-soluble matter being soluble in toluene at 100° C., is measured by gel permeation chromatography (GPC) as follows.

First, the crystalline polyester is dissolved in toluene at 100° C. over a period of one hour. The obtained solution is filtered through a solvent-resistant membrane filter “Maishori Disc” (manufactured by Tosoh Corporation) having a pore diameter of 0.2 μm to obtain a sample solution. The sample solution is adjusted such that the concentration of the component soluble in toluene is about 0.1% by mass. Measurement is performed using this sample solution under the following conditions.
Apparatus: HLC-8121 GPC/HT (manufactured by Tosoh Corporation)
Columns: connected two columns, TSKgel GMHHR-H HT (7.8 cm I.D×30 cm) (manufactured by Tosoh Corporation)
Detector: RI for high temperature
Temperature: 135° C.
Solvent: toluene
Flow rate: 1.0 mL/min
Sample: 0.4 mL of a 0.1% sample is injected

The molecular weight of a sample is calculated by using a molecular weight calibration curve prepared by using monodisperse polystyrene standard samples. Furthermore, the molecular weight is calculated by performing polyethylene conversion using the conversion formula derived from the Mark-Houwink viscosity equation.

### Method for Measuring Glass Transition Temperature Tg of Amorphous Resin

The glass transition temperature Tg of an amorphous resin is measured using a differential scanning calorimeter “Q2000” (manufactured by TA Instruments) in accordance with ASTM D3418-82. The melting points of indium and zinc are used for the temperature correction of a detecting unit of the apparatus, and the heat of fusion of indium is used for the correction of heat quantity. Specifically, about 3 mg of an amorphous resin is precisely weighed, placed in an aluminum pan, and measured under the following conditions while an empty aluminum pan is used as a reference.
Temperature rise rate: 10° C./min
Measurement start temperature: 30° C.
Measurement end temperature: 180° C.

The measurement is performed in a measurement range of 30° C. to 180° C. at a temperature rise rate of 10° C./min. The temperature is increased to 180° C. once and held for 10 minutes, then decreased to 30° C., and then increased again. In this second temperature rise process, a change in specific heat is observed in a temperature range of 30° C. to 100° C. In this case, the intersection point of a line at the midpoint of the baselines before and after the change in specific heat appears and the differential thermal curve is defined as the glass transition temperature Tg of the amorphous resin.

### Method for Measuring Melt Peak Temperature (Melting Point) T_{c} (° C.) of Crystalline Polyester or the Like

The melting point (T_{c}) of a crystalline polyester is measured using a differential scanning calorimeter “Q2000” (manufactured by TA Instruments) in accordance with ASTM D3418-82.

The melting points of indium and zinc are used for the temperature correction of a detecting unit of the apparatus, and the heat of fusion of indium is used for the correction of heat quantity. Specifically, 3 mg of a sample is precisely weighed, placed in an aluminum pan, and measured under the following conditions while an empty aluminum pan is used as a reference.
Temperature rise rate: 10° C./min
Measurement start temperature: 30° C.
Measurement end temperature: 180° C.

The measurement is performed in a measurement range of 30° C. to 180° C. at a temperature rise rate of 10° C./min. The temperature is increased to 180° C. once and held for 10 minutes, then decreased to 30° C., and then increased again. In this second temperature rise process, the temperature of the maximum endothermic peak in a temperature-amount of heat absorption curve in a range of 30° C. to 100° C. is defined as the melting point.

### EXAMPLES

The present disclosure will be described in more detail with reference to Examples and Comparative Examples. However, the present disclosure is not limited thereto. In the following formulations, “part” is based on mass unless otherwise specified.

### Production of Amorphous Resin A1

Polyethylene terephthalate (molecular weight: 2,000, intrinsic viscosity: 0.1): 20.9 parts (42.0% by mole)
Propylene oxide adduct of bisphenol A (average number of moles added: 2.0 moles): 47.4 parts (29.0% by mole)
Terephthalic acid: 15.8 parts (18.3% by mole)
Dodecenylsuccinic acid: 15.8 parts (10.6% by mole)
Titanium tetrabutoxide (esterification catalyst): 0.5 parts
Gallic acid (esterification promoter): 0.1 parts

The above materials were weighed into a reaction vessel equipped with a reflux condenser, a stirrer, a nitrogen introduction tube, and a thermocouple.

Note that the molar proportion of polyethylene terephthalate is a value of a total number of units of the number of units derived from ethylene glycol and the number of units derived from terephthalic acid.

Next, the inside of the reaction vessel was purged with a nitrogen gas, the temperature was then gradually raised with stirring, and a reaction was performed for two hours at a temperature of 200° C. with stirring.

Furthermore, the pressure in the reaction vessel was decreased to 8.3 kPa, and the reaction was performed for five hours while the temperature of 200° C. was maintained. After it was confirmed that the weight-average molecular weight reached 6,700, the temperature was decreased to stop the reaction. Thus, an amorphous resin A1 having a polyethylene terephthalate structural moiety in its molecule was obtained. Physical properties of the amorphous resin A1 determined by the measurement methods described above are shown in Table 1-1.

### Production of Amorphous Resins A2 to A10 and Amorphous Resins A12 to A17

Amorphous resins A2 to A10 and A12 to A17 having a polyethylene terephthalate structural moiety in their molecules were obtained by conducting the reaction in the same manner except that, in the production of the amorphous resin A1, the types and the numbers of parts of polyethylene terephthalate and polymerizable monomers were changed as shown in Tables 1-1 to 1-3. Physical properties of the amorphous resins A2 to A10 and A12 to A17 determined by the measurement methods described above are shown in Tables 1-1 to 1-3.

### Production of Amorphous Resin A11

Polyethylene terephthalate (molecular weight: 2,000, intrinsic viscosity: 0.1): 22.6 parts (41.1% by mole)
Propylene oxide adduct of bisphenol A (average number of moles added: 2.0 moles): 55.0 parts (29.5% by mole)
Terephthalic acid: 5.5 parts (5.6% by mole)
Suberic acid: 16.0 parts (23.8% by mole)
Titanium tetrabutoxide (esterification catalyst): 0.5 parts
Gallic acid (esterification promoter): 0.1 parts

The above materials were weighed into a reaction vessel equipped with a reflux condenser, a stirrer, a nitrogen introduction tube, and a thermocouple.

Next, the inside of the reaction vessel was purged with a nitrogen gas, the temperature was then gradually raised with stirring, and a reaction was performed for two hours at a temperature of 200° C. with stirring.

Furthermore, the pressure in the reaction vessel was decreased to 8.3 kPa, and the reaction was performed for five hours while the temperature of 200° C. was maintained. After it was confirmed that the weight-average molecular weight reached 6,700, the temperature was decreased to stop the reaction. Thus, an amorphous resin A11 having a polyethylene terephthalate structural moiety in its molecule was obtained. Physical properties of the amorphous resin A11 determined by the measurement methods described above were as follows: SP value, 11.30 (cal/cm³)^{0.5}; W_{EG}, 20.8% by mole; W_{CH}, 23.8% by mole; Tg, 48.5° C.

TABLE 1-1

| | | Amorphous | | Amorphous | | Amorphous | | Amorphous | | Amorphous | | Amorphous | |
|---|---|---|---|---|---|---|---|---|---|---|---|---|---|
| | | resin | | resin | | resin | | resin | | resin | | resin | |
| | | A1 | | A2 | | A3 | | A4 | | A5 | | A6 | |
| | | parts | mol % | parts | mol % | parts | mol % | parts | mol % | parts | mol % | parts | mol % |
| Polyethylene terephthalate | | 20.9 | 42.0 | 19.7 | 40.3 | 19.4 | 39.9 | 22.7 | 44.4 | 23.0 | 44.8 | 12.3 | 27.2 |
| Alcohol | BPA-PO | 47.4 | 29.0 | 44.6 | 27.9 | 44.0 | 27.6 | 51.5 | 30.7 | 52.2 | 30.9 | 52.6 | 36.4 |
| component | BPA-EO | | | | | | | | | | | | |
| | Ethylene glycol | | | | | | | | | | | | |
| Carboxylic | Terephthalic acid | 15.8 | 18.3 | 14.9 | 17.6 | 14.7 | 17.4 | 17.2 | 19.3 | 17.4 | 19.5 | 17.5 | 23.0 |
| acid | Dodecenylsuccinic acid | 15.8 | 10.6 | 20.8 | 14.3 | 22.0 | 15.2 | 8.6 | 5.6 | 7.4 | 4.8 | 17.5 | 13.4 |
| component | Tetradecanedioic acid | | | | | | | | | | | | |
| | Suberic acid | | | | | | | | | | | | |
| | Octadecanedioic acid | | | | | | | | | | | | |
| | Adipic acid | | | | | | | | | | | | |
| | Eicosanedioic acid | | | | | | | | | | | | |
| | Trimellitic acid | | | | | | | | | | | | |

| | | | | | | | |
|---|---|---|---|---|---|---|---|
| Physical | SP | 11.30 | 11.26 | 11.25 | 11.37 | 11.38 | 11.13 |
| properties | W_{EG} | 21.4 | 20.6 | 20.3 | 22.6 | 22.8 | 13.4 |
| | W_{CH} | 10.6 | 14.3 | 15.2 | 5.6 | 4.8 | 13.4 |
| | Tg | 45.3 | 40.5 | 39.8 | 54.8 | 55.5 | 42.3 |
| | Mw | 6700 | 6700 | 6700 | 6700 | 6700 | 6700 |

TABLE 1-2

| | | Amorphous | | Amorphous | | Amorphous | | Amorphous | | Amorphous | |
|---|---|---|---|---|---|---|---|---|---|---|---|
| | | resin A7 | | resin A8 | | resin A9 | | resin A10 | | resin A12 | |
| | | parts | mol % | parts | mol % | parts | mol % | parts | mol % | parts | mol % |
| Polyethylene terephthalate | | 11.0 | 24.9 | 25.4 | 47.9 | 27.0 | 49.9 | 22.7 | 43.1 | 23.0 | 44.7 |
| Alcohol | BPA-PO | 53.4 | 37.6 | 44.8 | 26.1 | 43.8 | 25.1 | 50.6 | 29.8 | 52.2 | 30.9 |
| component | BPA-EO | | | | | | | | | | |
| | Ethylene glycol | | | | | | | | | | |
| Carboxylic | Terephthalic acid | 17.8 | 23.7 | 14.9 | 16.4 | 14.6 | 15.8 | 16.9 | 18.8 | 17.4 | 19.5 |
| acid | Dodecenylsuccinic acid | 17.8 | 13.8 | 14.9 | 9.6 | 14.6 | 9.2 | | | | |
| component | Tetradecanedioic acid | | | | | | | 10.1 | 8.3 | | |
| | Suberic acid | | | | | | | | | | |
| | Octadecanedioic acid | | | | | | | | | 7.4 | 4.9 |
| | Adipic acid | | | | | | | | | | |
| | Eicosanedioic acid | | | | | | | | | | |
| | Trimellitic acid | | | | | | | | | | |

| | | | | | | |
|---|---|---|---|---|---|---|
| Physical | SP | 11.10 | 11.40 | 11.44 | 11.30 | 11.30 |
| properties | W_{EG} | 12.5 | 24.1 | 25.0 | 22.0 | 22.8 |
| | W_{CH} | 13.8 | 9.6 | 9.2 | 8.3 | 4.9 |
| | Tg | 41.8 | 48.2 | 49.1 | 46.1 | 45.9 |
| | Mw | 6700 | 6700 | 6700 | 6700 | 6700 |

TABLE 1-3

| | | Amorphous | | Amorphous | | Amorphous | | Amorphous | | Amorphous | |
|---|---|---|---|---|---|---|---|---|---|---|---|
| | | resin A13 | | resin A14 | | resin A15 | | resin A16 | | resin A17 | |
| | | parts | mol % | parts | mol % | parts | mol % | parts | mol % | parts | mol % |
| Polyethylene terephthalate | | 10.0 | 22.9 | 28.5 | 51.7 | 22.6 | 41.1 | 23.0 | 45.1 | 28.7 | 55.7 |
| Alcohol | BPA-PO | 54.0 | 38.6 | 42.9 | 24.2 | 55.0 | 29.5 | 52.4 | 31.1 | 36.6 | 21.7 |
| component | BPA-EO | | | | | | | | | 14.6 | 9.5 |
| | Ethylene glycol | | | | | | | | | | |
| Carboxylic | Terephthalic acid | 18.0 | 24.3 | 14.3 | 15.2 | 5.5 | 5.6 | 17.5 | 19.6 | 2.2 | 2.5 |
| acid | Dodecenylsuccinic acid | 18.0 | 14.1 | 14.3 | 8.9 | | | | | 9.3 | 6.1 |
| component | Tetradecanedioic acid | | | | | | | | | | |
| | Suberic acid | | | | | | | | | | |
| | Octadecanedioic acid | | | | | | | | | | |
| | Adipic acid | | | | | 16.0 | 23.8 | | | | |
| | Eicosanedioic acid | | | | | | | 7.0 | 4.2 | | |
| | Trimellitic acid | | | | | | | | | 8.6 | 4.5 |

| | | | | | | |
|---|---|---|---|---|---|---|
| Physical | SP | 11.08 | 11.47 | 11.30 | 11.30 | 11.45 |
| properties | W_{EG} | 11.4 | 25.9 | 20.8 | 23.0 | 28.3 |
| | W_{CH} | 14.1 | 8.9 | 23.8 | 4.2 | 6.1 |
| | Tg | 41.1 | 49.7 | 49.1 | 45.6 | 53.0 |
| | Mw | 6700 | 6700 | 6700 | 6700 | 6700 |

The abbreviations in Tables 1-1 to 1-3 are as follows.

### BPA-PO:

Propylene oxide adduct of bisphenol A (average number of moles added: 2.0 moles)

### BPA-EO:

Ethylene oxide adduct of bisphenol A (average number of moles added: 2.0 moles)

### Production of Amorphous Resin B1

Polyethylene terephthalate (molecular weight: 2,000, intrinsic viscosity: 0.1): 4.1 parts (9.8% by mole)
Propylene oxide adduct of bisphenol A (average number of moles added: 2.0 moles): 57.8 parts (42.8% by mole)
Terephthalic acid: 29.9 parts (41.9% by mole)
Trimellitic acid: 7.0 parts (4.5% by mole)
Stearic acid: 1.2 parts (1.0% by mole)
Titanium tetrabutoxide (esterification catalyst): 0.5 parts
Gallic acid (esterification promoter): 0.1 parts

The above materials were weighed into a reaction vessel equipped with a reflux condenser, a stirrer, a nitrogen introduction tube, and a thermocouple.

Next, the inside of the reaction vessel was purged with a nitrogen gas, the temperature was then gradually raised with stirring, and a reaction was performed for two hours at a temperature of 200° C. with stirring.

Furthermore, the pressure in the reaction vessel was decreased to 8.3 kPa, and the reaction was performed for five hours while the temperature of 200° C. was maintained. After it was confirmed that the weight-average molecular weight reached 1,000, the temperature was decreased to stop the reaction. Thus, an amorphous resin B1 was obtained. Physical properties of the amorphous resin B1 determined by the measurement methods described above are shown in Table 2.

### Production of Amorphous Resins B2 to B5

Amorphous resins B2 to B5 were obtained by conducting the reaction in the same manner except that, in the production of the amorphous resin B1, the numbers of parts of polyethylene terephthalate and polymerizable monomers were changed as shown in Table 2. Physical properties of the amorphous resins B2 to B5 determined by the measurement methods described above are shown in Table 2.

TABLE 2

| | | Amorphous | | Amorphous | | Amorphous | | Amorphous | | Amorphous | |
|---|---|---|---|---|---|---|---|---|---|---|---|
| | | resin | | resin | | resin | | resin | | resin | |
| | | B1 | | B2 | | B3 | | B4 | | B5 | |
| | | parts | mol % | parts | mol % | parts | mol % | parts | mol % | parts | mol % |
| Polyethylene terephthalate | | 4.1 | 9.8 | 4.0 | 9.6 | 4.0 | 9.5 | 4.0 | 9.8 | 4.0 | 9.9 |
| Alcohol | BPA-PO | 57.8 | 42.8 | 56.8 | 42.2 | 56.8 | 41.5 | 56.8 | 43.0 | 56.8 | 43.1 |
| component | | | | | | | | | | | |
| Carboxylic | Terephthalic acid | 29.9 | 41.9 | 29.4 | 41.2 | 29.4 | 40.6 | 29.4 | 42.1 | 29.4 | 42.2 |
| acid | Stearic acid | 1.2 | 1.0 | 2.9 | 2.5 | 4.9 | 4.2 | 0.6 | 0.5 | 0.3 | 0.3 |
| component | Trimellitic acid | 7.0 | 4.5 | 6.9 | 4.4 | 6.9 | 4.4 | 6.9 | 4.5 | 6.9 | 4.5 |

| | | | | | | |
|---|---|---|---|---|---|---|
| Physical | SP | 11.54 | 11.49 | 11.43 | 11.56 | 11.57 |
| properties | W_{EG} | 4.9 | 4.8 | 4.8 | 4.9 | 4.9 |
| | W_{CH} | 1.0 | 2.5 | 4.2 | 0.5 | 0.3 |
| | Tg | 74.7 | 65.0 | 63.0 | 88.0 | 92.0 |
| | Mw | 1000 | 1000 | 1000 | 1000 | 1000 |

The abbreviation in Table 2 is as follows.

### BPA-PO:

Propylene oxide adduct of bisphenol A (average number of moles added: 2.0 moles)
   Production of crystalline polyester C1
Ethylene glycol: 10.2 parts (48.2% by mole)
Tetradecanedioic acid: 81.3 parts (48.3% by mole)
Behenic acid: 8.5 parts (3.5% by mole)
Titanium tetrabutoxide (esterification catalyst): 0.5 parts

The above materials were weighed into a reaction vessel equipped with a reflux condenser, a stirrer, a nitrogen introduction tube, and a thermocouple.

Next, the inside of the reaction vessel was purged with a nitrogen gas, the temperature was then gradually raised with stirring, and a reaction was performed for two hours at a temperature of 200° C. with stirring.

Furthermore, the pressure in the reaction vessel was decreased to 8.3 kPa, and the reaction was performed for five hours while the temperature of 200° C. was maintained. The temperature was then decreased to stop the reaction. Thus, a crystalline polyester C1 was obtained. Physical properties of the crystalline polyester C1 determined by the measurement methods described above are shown in Table 3.

### Production of Crystalline Polyesters C2 to C5

Crystalline polyesters C2 to C5 were obtained by conducting the reaction in the same manner except that, in the production of the crystalline polyester C1, the types and the numbers of parts of polymerizable monomers and an aliphatic monocarboxylic acid or an aliphatic monoalcohol were changed as shown in Table 3. Physical properties of the crystalline polyesters C2 to C5 determined by the measurement methods described above are shown in Table 3.

TABLE 3

| | | Crystalline | | Crystalline | | Crystalline | | Crystalline | | Crystalline | |
|---|---|---|---|---|---|---|---|---|---|---|---|
| | | polyester | | polyester | | polyester | | polyester | | polyester | |
| | | C1 | | C2 | | C3 | | C4 | | C5 | |
| | | parts | mol % | parts | mol % | parts | mol % | parts | mol % | parts | mol % |
| Alcohol | Ethylene glycol | 10.2 | 48.2 | 10.2 | 47.6 | 10.2 | 47.5 | 10.1 | 48.5 | 10.1 | 48.7 |
| component | (number of carbon | | | | | | | | | | |
| | atoms: 2) | | | | | | | | | | |
| Carboxylic | Tetradecanedioic | 81.3 | 48.3 | 81.3 | 47.7 | 81.3 | 47.5 | 81.1 | 48.6 | 81.1 | 48.7 |
| acid | acid | | | | | | | | | | |
| component | | | | | | | | | | | |
| Aliphatic | Behenic acid | 8.5 | 3.5 | | | | | | | | |
| monocarboxylic | (number of carbon | | | | | | | | | | |
| acid | atoms: 22) | | | | | | | | | | |
| | Palmitic acid | | | 8.5 | 4.7 | | | | | | |
| | (number of carbon | | | | | | | | | | |
| | atoms: 16) | | | | | | | | | | |
| | Pentadecanoic | | | | | 8.5 | 5.0 | | | | |
| | acid | | | | | | | | | | |
| | (number of carbon | | | | | | | | | | |
| | atoms: 15) | | | | | | | | | | |
| | Montanic acid | | | | | | | 8.8 | 2.9 | | |
| | (number of carbon | | | | | | | | | | |
| | atoms: 28) | | | | | | | | | | |
| | Lacceric acid | | | | | | | | | 8.8 | 2.6 |
| | (number of carbon | | | | | | | | | | |
| | atoms: 32) | | | | | | | | | | |

| | | | | | | |
|---|---|---|---|---|---|---|
| Physical | SP | 10.09 | 10.11 | 10.12 | 10.09 | 10.08 |
| properties | Tc | 92.0 | 90.0 | 89.0 | 94.0 | 95.0 |
| | Mw | 18000 | 18000 | 18000 | 18000 | 18000 |

### Production Example of Toner 1

Amorphous resin A1: 66 parts
Amorphous resin B1: 34 parts
Crystalline polyester CI: 10 parts
Fischer-Tropsch wax (peak temperature of maximum endothermic peak: 100° C.): 5 parts
Carbon black: 5 parts
Trisodium phosphate: 0.160 parts

The above materials were mixed using a Henschel mixer (model FM-75, manufacture by Mitsui Mining Co., Ltd.) at a rotation speed of 1,500 rpm for a rotation time of five minutes and then kneaded using a twin-screw kneader (model PCM-30, manufactured by Ikegai Corporation) with the temperature set to 130° C. The obtained kneaded product was cooled and roughly pulverized to 1 mm or smaller with a hammer mill to obtain a roughly pulverized product. The roughly pulverized product was finely pulverized with a mechanical pulverizer (T-250, manufactured by Turbo Kogyo Co., Ltd.). Furthermore, classification was performed using Faculty (F-300, manufactured by Hosokawa Micron Corporation) to obtain toner particles 1. The operating conditions were as follows: classification rotor rotation speed, 11,000 rpm; dispersion rotor rotation speed, 7,200 rpm.
Toner particles 1:95 parts
Large-particle-diameter inorganic fine particles: Fumed silica subjected to surface treatment with hexamethyldisilazane
(median diameter (D50) (on a number basis): 120 nm): 4 parts
Small-particle-diameter inorganic fine particles: fine titanium oxide particles subjected to surface treatment with isobutyltrimethoxysilane
(median diameter (D50) (on a number basis): 10 nm): 1 part

The above materials were mixed using a Henschel Mixer (model FM-75, manufactured by Mitsui Miike Kakoki K.K.) at a rotation speed of 1,900 rpm for a rotation time of 10 minutes to obtain a toner 1 with negative chargeability. Physical properties of the toner 1 determined by the measurement methods described above are shown in Table 4.

### Production Examples of Toners 2 to 35

Toners 2 to 35 were obtained by conducting the same operations as those in the production example of the toner 1 except that, in the production example of the toner 1, the types and the numbers of parts of the amorphous resin A, the amorphous resin B, the crystalline polyester C, and the additive were changed as shown in Table 4. Physical properties of the toners 2 to 35 determined by the measurement methods described above are shown in Table 4.

TABLE 4

| | Formulation/Physical properties | | | | | | | | | |
|---|---|---|---|---|---|---|---|---|---|---|
| Toner | Amorphous resin A | | Amorphous resin B | | Crystalline polyester C | Additive | | W_{P} | SP_{A}-SP_{C} | W_{B}/W_{A} |
| Type | Type | parts | Type | parts | Type | Type | parts | ppm | — | — |
| 1 | 1 | 66 | 1 | 34 | 1 | PNa | 0.160 | 250 | 1.21 | 0.52 |
| 2 | 1 | 60 | 1 | 40 | 1 | PNa | 0.160 | 250 | 1.21 | 0.67 |
| 3 | 1 | 58 | 1 | 42 | 1 | PNa | 0.160 | 250 | 1.21 | 0.72 |
| 4 | 1 | 82 | 1 | 18 | 1 | PNa | 0.160 | 250 | 1.21 | 0.22 |
| 5 | 1 | 66 | 2 | 34 | 1 | PNa | 0.160 | 250 | 1.21 | 0.52 |
| 6 | 1 | 66 | 3 | 34 | 1 | PNa | 0.160 | 250 | 1.21 | 0.52 |
| 7 | 1 | 66 | 4 | 34 | 1 | PNa | 0.160 | 250 | 1.21 | 0.52 |
| 8 | 1 | 66 | 5 | 34 | 1 | PNa | 0.160 | 250 | 1.21 | 0.52 |
| 9 | 2 | 66 | 1 | 34 | 1 | PNa | 0.160 | 250 | 1.17 | 0.52 |
| 10 | 3 | 66 | 1 | 34 | 1 | PNa | 0.160 | 250 | 1.16 | 0.52 |
| 11 | 4 | 66 | 1 | 34 | 1 | PNa | 0.160 | 250 | 1.28 | 0.52 |
| 12 | 5 | 66 | 1 | 34 | 1 | PNa | 0.160 | 250 | 1.29 | 0.52 |
| 13 | 1 | 66 | 1 | 34 | 2 | PNa | 0.160 | 250 | 1.19 | 0.52 |
| 14 | 1 | 66 | 1 | 34 | 3 | PNa | 0.160 | 250 | 1.18 | 0.52 |
| 15 | 1 | 66 | 1 | 34 | 4 | PNa | 0.160 | 250 | 1.22 | 0.52 |
| 16 | 1 | 66 | 1 | 34 | 5 | PNa | 0.160 | 250 | 1.23 | 0.52 |
| 17 | 6 | 66 | 1 | 34 | 1 | PNa | 0.160 | 250 | 1.04 | 0.52 |
| 18 | 7 | 66 | 1 | 34 | 1 | PNa | 0.160 | 250 | 1.01 | 0.52 |
| 19 | 8 | 66 | 1 | 34 | 1 | PNa | 0.160 | 250 | 1.31 | 0.52 |
| 20 | 9 | 66 | 1 | 34 | 1 | PNa | 0.160 | 250 | 1.35 | 0.52 |
| 21 | 1 | 66 | 1 | 34 | 1 | PNa | 0.320 | 500 | 1.21 | 0.52 |
| 22 | 1 | 66 | 1 | 34 | 1 | PNa | 0.015 | 20 | 1.21 | 0.52 |
| 23 | 1 | 66 | 1 | 34 | 1 | PNa | 0.004 | 5 | 1.21 | 0.52 |
| 24 | 1 | 66 | 1 | 34 | 1 | PF | 0.320 | 250 | 1.21 | 0.52 |
| 25 | 10 | 66 | 1 | 34 | 1 | PNa | 0.160 | 250 | 1.21 | 0.52 |
| 26 | 11 | 66 | 1 | 34 | 1 | PNa | 0.160 | 250 | 1.21 | 0.52 |
| 27 | 12 | 66 | 1 | 34 | 1 | PNa | 0.160 | 250 | 1.21 | 0.52 |
| 28 | 13 | 66 | 1 | 34 | 1 | PNa | 0.160 | 250 | 0.99 | 0.52 |
| 29 | 14 | 66 | 1 | 34 | 1 | PNa | 0.160 | 250 | 1.38 | 0.52 |
| 30 | 1 | 66 | 1 | 34 | 1 | PNa | 0.400 | 600 | 1.21 | 0.52 |
| 31 | 1 | 66 | 1 | 34 | 1 | PNa | 0.002 | 3 | 1.21 | 0.52 |
| 32 | 1 | 66 | 1 | 34 | 1 | — | — | 0 | 1.21 | 0.52 |
| 33 | 15 | 66 | 1 | 34 | 1 | PNa | 0.160 | 250 | 1.21 | 0.52 |
| 34 | 16 | 66 | 1 | 34 | 1 | PNa | 0.160 | 250 | 1.21 | 0.52 |
| 35 | 17 | 66 | 1 | 34 | 1 | PNa | 0.160 | 250 | 1.36 | 0.52 |

The abbreviations in Table 4 are as follows.
PNa: trisodium phosphate
PF: triphenyl phosphate
SP_{A}−SP_{C}: [SP value of amorphous resin A (cal/cm³)^{0.5}]−[SP value of crystalline polyester C (cal/cm³)^{0.5}]
W_{B}/W_{A}: [parts by mass of amorphous resin B]/[parts by mass of amorphous resin A]

### Production Example of Magnetic Carrier 1

Magnetite 1 having a number-average particle diameter of 0.30 μm (magnetization intensity of 65 Am²/kg under a magnetic field of 1,000/4π (kA/m))
Magnetite 2 having a number-average particle diameter of 0.50 μm (magnetization intensity of 65 Am²/kg under a magnetic field of 1,000/4π (kA/m))

To 100 parts of each of the above materials, 4.0 parts of a silane compound (3-(2-aminoethylaminopropyl) trimethoxysilane) was added. The resulting mixture was mixed and stirred at a high speed at 100° C. or higher in a vessel to treat the fine particles of each of the materials.
Phenol: 10% by mass
Formaldehyde solution: 6% by mass (40% by mass of formaldehyde, 10% by mass of methanol, and 50% by mass of water)
Magnetite 1 treated with the above silane compound: 58% by mass
Magnetite 2 treated with the above silane compound: 26% by mass

In a flask, 100 parts of the above materials, 5 parts of a 28% by mass aqueous ammonia solution, and 20 parts of water were placed, and were heated to 85° C. over 30 minutes while stirring and mixing. A polymerization reaction was caused by holding the temperature for three hours to cure the resulting phenolic resin. The cured phenolic resin was then cooled to 30° C., and water was further added thereto. The supernatant was then removed, and the precipitate was washed with water and then air-dried. Subsequently, the resulting product was dried at a temperature of 60° C. under reduced pressure (5 mmHg or less) to provide a magnetic material-dispersed, spherical magnetic carrier 1. The 50% particle diameter (D50) was 34.21 μm on a volume basis.

### Production Example of Two-Component Developer 1

A two-component developer 1 was obtained by mixing 92.0 parts of the magnetic carrier 1 and 8.0 parts of the toner 1 using a V-type mixer (V-20, manufactured by SEISHIN ENTERPRISE Co., Ltd.).

### Production Examples of Two-Component Developers 2 to 35

Two-component developers 2 to 35 were obtained by conducting the same operation as that in the production example of the two-component developer 1 except for the changes shown in Table 5.

### Example 1

Evaluations were performed using the two-component developer 1.

A modified apparatus imagePressC800 (manufactured by CANON KABUSHIKI KAISHA), which is a printer for digital commercial printing, was used as an image forming apparatus, and the two-component developer 1 was placed in a developing device at a cyan position. The apparatus was modified such that the fixing temperature, the process speed, the direct current voltage V_{DC} of a developer-bearing member, the charging bias V_{D} of an electrostatic latent image-bearing member, and the laser power could be freely set. Image output was evaluated by outputting an FFh image (solid image) having a desired image ratio and adjusting V_{DC}, V_{D}, and the laser power such that the toner coverage on the FFh image on paper reached a desired value, and the following evaluations were performed. FFh is a value that expresses 256 tones in hexadecimal, 00h is the first tone (white background portion) of the 256 tones, and FFh is the 256th tone (solid portion) of the 256 tones. The evaluations were conducted on the basis of evaluation methods described below. The results are shown in Table 5.

### Scratch Resistance

Paper: UPM FINESSE GLOSS 300GSM
Toner coverage on paper: 0.05 mg/cm² (2Fh image)
(The toner coverage was adjusted by the direct current voltage V_{DC} of the developer-bearing member, the charging bias V_{D} of the electrostatic latent image-bearing member, and the laser power)
Evaluation image: a 3 cm×15 cm image placed at the center of the above-mentioned A4 size sheet
Fixing test environment: normal-temperature normal-humidity environment (temperature: 23° C./humidity: 50% RH (hereinafter, referred to as “N/N”))
Fixing temperature: 180° C.
Process speed: 377 mm/see

The above evaluation image was output, and scratch resistance was evaluated. Specifically, a weight of 200 g was placed, the image was scratched by a length of 30 mm with a needle having a diameter of 0.75 mm at a speed of 60 mm/min using a surface property tester HEIDON TYPE 14FW, manufactured by Shinto Scientific Co., Ltd., and evaluation was performed based on the scratch generated on the image. The ratio of the area where the toner had been peeled off was determined by performing image processing to binarize the area where the toner had been peeled off with respect to the scratched area.

### Evaluation Criteria

A: 0.0%
B: 0.1% or more and less than 0.4%
C: 0.4% or more and less than 0.9%
D: 0.9% or more and less than 1.1%
E: 1.1% or more

### Low-Temperature Fixability

Paper: GFC-081 (81.0 g/m²) (available from Canon Marketing Japan Inc.)
Toner coverage on paper: 0.50 mg/cm²
(The toner coverage was adjusted by the direct current voltage V_{DC} of the developer-bearing member, the charging bias V_{D} of the electrostatic latent image-bearing member, and the laser power)
Evaluation image: a 2 cm×5 cm image placed at the center of the above-mentioned A4 size sheet
Test environment: low-temperature low-humidity environment (temperature: 15° C./humidity: 10% RH (hereinafter, referred to as “L/L”))
Fixing temperature: 150° C.
Process speed: 630 mm/sec

The above evaluation image was output, and low-temperature fixability was evaluated. The value of the rate of decrease in image density was used as an evaluation index of low-temperature fixability.

First, the image density in a center portion was measured with an X-Rite color reflection densitometer (500 Series: manufactured by X-Rite Inc.). Next, the fixed image was rubbed (5 reciprocations) with lens-cleaning paper while a load of 4.9 kPa (50 g/cm²) was applied to the portion where the image density had been measured, and the image density was measured again.

The rate of decrease in image density before and after rubbing was calculated by the following equation. The rate of decrease in image density was evaluated in accordance with the following evaluation criteria. The ratings A to C were determined to be good.

Rate of decrease in image density (%)=(image density before rubbing−image density after rubbing)/image density before rubbing×100

### Evaluation Criteria

A: The rate of decrease in image density is less than 3%.
B: The rate of decrease in image density is 3% or more and less than 5%.
C: The rate of decrease in image density is 5% or more and less than 8%.
D: The rate of decrease in image density is 8% or more and less than 10%.
E: The rate of decrease in image density is 10% or more.

### Examples 2 to 27 and Comparative Examples 1 to 8

The evaluations were performed as in Example 1 except that the two-component developers 2 to 35 were used. The evaluation results are shown in Table 5.

TABLE 5

| | Two-component | | Magnetic | Low-temperature fixability | | | | Scratch | |
|---|---|---|---|---|---|---|---|---|---|
| | developer | Toner | carrier | | Image density | Image density | Rate of | resistance | |
| | Type | Type | Type | | before rubbing | after rubbing | decrease | | Area ratio |
| Example 1 | 1 | 1 | 1 | A | 1.35 | 1.32 | 2% | A | 0.0% |
| Example 2 | 2 | 2 | 1 | B | 1.35 | 1.31 | 3% | A | 0.0% |
| Example 3 | 3 | 3 | 1 | C | 1.35 | 1.28 | 5% | A | 0.0% |
| Example 4 | 4 | 4 | 1 | A | 1.35 | 1.32 | 2% | B | 0.3% |
| Example 5 | 5 | 5 | 1 | A | 1.35 | 1.32 | 2% | B | 0.3% |
| Example 6 | 6 | 6 | 1 | A | 1.35 | 1.32 | 2% | C | 0.7% |
| Example 7 | 7 | 7 | 1 | B | 1.35 | 1.31 | 3% | A | 0.0% |
| Example 8 | 8 | 8 | 1 | C | 1.35 | 1.28 | 5% | A | 0.0% |
| Example 9 | 9 | 9 | 1 | A | 1.35 | 1.32 | 2% | C | 0.8% |
| Example 10 | 10 | 10 | 1 | A | 1.35 | 1.32 | 2% | D | 1.0% |
| Example 11 | 11 | 11 | 1 | B | 1.35 | 1.31 | 3% | C | 0.8% |
| Example 12 | 12 | 12 | 1 | C | 1.35 | 1.28 | 5% | D | 1.0% |
| Example 13 | 13 | 13 | 1 | A | 1.35 | 1.32 | 2% | B | 0.3% |
| Example 14 | 14 | 14 | 1 | A | 1.35 | 1.32 | 2% | C | 0.7% |
| Example 15 | 15 | 15 | 1 | B | 1.35 | 1.31 | 3% | B | 0.3% |
| Example 16 | 16 | 16 | 1 | C | 1.35 | 1.28 | 5% | C | 0.7% |
| Example 17 | 17 | 17 | 1 | A | 1.35 | 1.32 | 2% | C | 0.8% |
| Example 18 | 18 | 18 | 1 | A | 1.35 | 1.32 | 2% | D | 1.0% |
| Example 19 | 19 | 19 | 1 | B | 1.35 | 1.31 | 3% | C | 0.8% |
| Example 20 | 20 | 20 | 1 | C | 1.35 | 1.28 | 5% | D | 1.0% |
| Example 21 | 21 | 21 | 1 | D | 1.35 | 1.23 | 9% | C | 0.8% |
| Example 22 | 22 | 22 | 1 | A | 1.35 | 1.32 | 2% | D | 1.0% |
| Example 23 | 23 | 23 | 1 | A | 1.35 | 1.32 | 2% | D | 1.0% |
| Example 24 | 24 | 24 | 1 | A | 1.35 | 1.32 | 2% | C | 0.7% |
| Example 25 | 25 | 25 | 1 | B | 1.35 | 1.31 | 3% | B | 0.3% |
| Example 26 | 26 | 26 | 1 | C | 1.35 | 1.28 | 5% | C | 0.8% |
| Example 27 | 27 | 27 | 1 | A | 1.35 | 1.32 | 2% | D | 1.0% |
| Comparative Example 1 | 28 | 28 | 1 | A | 1.35 | 1.32 | 2% | E | 1.3% |
| Comparative Example 2 | 29 | 29 | 1 | E | 1.35 | 1.21 | 10% | E | 1.3% |
| Comparative Example 3 | 30 | 30 | 1 | E | 1.35 | 1.21 | 10% | E | 1.2% |
| Comparative Example 4 | 31 | 31 | 1 | A | 1.35 | 1.32 | 2% | E | 1.1% |
| Comparative Example 5 | 32 | 32 | 1 | A | 1.35 | 1.32 | 2% | E | 1.2% |
| Comparative Example 6 | 33 | 33 | 1 | E | 1.35 | 1.21 | 10% | E | 1.2% |
| Comparative Example 7 | 34 | 34 | 1 | A | 1.35 | 1.32 | 2% | E | 1.2% |
| Comparative Example 8 | 35 | 35 | 1 | E | 1.35 | 1.21 | 10% | E | 1.3% |

The present disclosure can provide a toner that exhibits good low-temperature fixability and scratch resistance. The toner according to the present disclosure enables polyethylene terephthalate recycled from used PET bottles and the like to be used as a material of a toner. The technologies described in this specification have the potential to contribute to the achievement of a sustainable society, such as a decarbonized society/circular society.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-049226 filed Mar. 26, 2024, No. 2024-172551 filed Oct. 1, 2024, and No. 2025-030138 filed Feb. 27, 2025, which are hereby incorporated by reference herein in their entirety.

What is claimed is:

1. A toner comprising:
toner particles containing a binder resin,
wherein the binder resin contains an amorphous resin A and a crystalline polyester C,
the amorphous resin A is a polyester and has, as a structure that forms a polyester backbone,
(i) a polyethylene terephthalate structural moiety, and
(ii) at least one structure selected from the group consisting of a unit represented by formula (1), a unit represented by formula (2), a unit represented by formula (3), and a unit represented by formula (4), 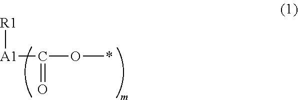
in formula (1), R1 represents an alkyl group having 6 to 16 carbon atoms or an alkenyl group having 6 to 16 carbon atoms,
A1 represents a hydrocarbon group,
* represents a bonding site in the polyester backbone, and
m represents an integer of 2 or more; 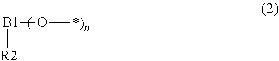
in formula (2), R2 represents an alkyl group having 6 to 16 carbon atoms or an alkenyl group having 6 to 16 carbon atoms,
B1 represents a hydrocarbon group,
* represents a bonding site in the polyester backbone, and
n represents an integer of 2 or more; 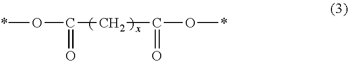
in formula (3), each * represents a bonding site in the polyester backbone, and
x represents an integer of 6 to 16; 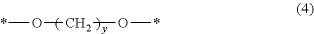
in formula (4), each * represents a bonding site in the polyester backbone, and
y represents an integer of 6 to 16;
an SP value of the amorphous resin A is represented by SP_{A} (cal/cm³)^{0.5}, an SP value of the crystalline polyester C is represented by SP_{C} (cal/cm³)^{0.5}, and SP_{A} and SP_{C} satisfy formula (C);
$$1. \leq {SP}_{A} - {SP}_{C} \leq 1.35 ; \qquad ( C )$$
the toner contains a phosphorus element derived from a phosphorus compound,
a content of the phosphorus element in the toner based on a mass of the toner is represented by W_{P} (ppm), and W_{P} satisfies formula (D);
$$5 \leq {W}_{P} \leq 500 . \qquad ( D )$$

2. The toner according to claim 1, wherein W_{P} satisfies formula (K):
$$20 \leq {W}_{P} \leq 500. \qquad ( K )$$

3. The toner according to claim 1, wherein a ratio of an ethylene glycol-derived structure of the polyethylene terephthalate structural moiety to a total number of moles of an alcohol-derived structure and a carboxylic acid-derived structure forming the polyester backbone in the amorphous resin A is represented by W_{EG} (% by mole), and W_{EG} satisfies formula (E):
$$12.6 \leq {W}_{EG} \leq 24.8 . \qquad ( E )$$

4. The toner according to claim 1, wherein a ratio of a total of the unit represented by formula (1), the unit represented by formula (2), the unit represented by formula (3), and the unit represented by formula (4) to a total number of moles of an alcohol-derived structure and a carboxylic acid-derived structure forming the polyester backbone in the amorphous resin A is represented by W_{CH} (% by mole), and W_{CH} satisfies formula (F):
$$5.6 \leq {W}_{CH} \leq 14.6 . \qquad ( F )$$

5. The toner according to claim 1, wherein the crystalline polyester C is a modified crystalline polyester having a structure in which a hydroxy group at a terminal of a main chain is terminally modified with an aliphatic monocarboxylic acid having 16 to 31 carbon atoms or a modified crystalline polyester having a structure in which a carboxy group at a terminal of a main chain is terminally modified with an aliphatic monoalcohol having 15 to 30 carbon atoms.

6. The toner according to claim 1, wherein the amorphous resin A contains the unit represented by formula (1) or the unit represented by formula (2).
